(19) United States
(12) Patent Application Publication
(10) Pub. No.: US 2005/0114131 A1
(43) Pub. Date: May 26, 2005

(54) Apparatus and method for voice-tagging lexicon

(76) Inventors: Kirill Stoimenov, Lompoc, CA (US); David Kryze, Santa Barbara, CA (US); Peter Veprek, Santa Barbara, CA (US)

Correspondence Address: HARNESS, DICKEY & PIERCE, P.L.C., P.O. BOX 828, BLOOMFIELD HILLS, MI, 48303, US

(21) Appl. No.: 10/720,798

(22) Filed: Nov. 24, 2003

(51) Int. Cl. G10L 15/04

(52) U.S. Cl. 704/251

(57) ABSTRACT

A voice-tag editor develops voice-tag “sounds like” pairs for a voice-tagging lexicon. The voice-tag editor is receptive of alphanumeric characters input by a user. The alphanumeric characters are indicative of a voice tag and/or “sounds like” text. The voice-tag editor is configured to allow the user to view and edit the alphanumeric characters. A text parser connected to the voice-tag editor generates normalized text corresponding to the “sounds like” text. The normalized text serves as recognition text for the voice tag and is displayed by the voice-tag editor. A storage mechanism is connected to the editor. The storage mechanism updates the lexicon with the alphanumeric characters which represent voice-tag “sounds like” pairs.

### FIELD OF THE INVENTION

The present invention relates to speech recognition lexicons, and more particularly to a tool for developing desired voice-tag “sounds like” pairs.

### BACKGROUND OF THE INVENTION

Developments in digital technologies in professional broadcasting, the movie industry, and home video have led to an increased production of multimedia data. Users of applications that involve large amounts of multimedia content must rely on metadata inserted in a multimedia data file to effectively manage and retrieve multimedia data. Metadata creation and management can be time-consuming and costly in multimedia applications. For example, to manage metadata for video multimedia data, an operator may be required to view the video in order to properly generate metadata by tagging specific content. The operator must repeatedly stop the video data to apply metadata tags. This process may take as much as four or five times longer than the real-time length of the video data. As a result, metadata tagging is one of the largest expenses associated with multimedia production.

Voice-tagging systems allow a user to speak a voice-tag into an automatic speech recognition system (ASR). The ASR converts the voice-tag into text to be inserted as meta-data in a multimedia data stream. Because the user does not need to stop or replay the data stream, voice-tagging can be done in real-time. In other embodiments, voice-tagging can be accomplished during live recording of multimedia data. An exemplary voice-tagging system 10 is shown in FIG. 1. A user plays multimedia data in a viewing window 12. As the multimedia data plays, the user may add a voice tag to the multimedia data by speaking a corresponding phrase into an audio input mechanism. For instance, the viewing window 12 includes an elapsed time 14. As the user speaks a phrase, a corresponding voice-tag is added to the multimedia data at a time indicated by the elapsed time 14. A voice-tag list 16 displays voice-tags that have been added to the multimedia data. A time field 18 indicates a time that a particular voice-tag was added to the multimedia data.

### SUMMARY OF THE INVENTION

A system for developing voice-tag “sounds like” pairs for a voice-tagging lexicon comprises a voice-tag editor receptive of alphanumeric characters indicative of a voice tag. The voice tag editor is configured to display and edit the alphanumeric characters. A text parser is connected to the editor and is operable to generate normalized text corresponding to the alphanumeric characters. The normalized text serves as recognition text for the voice tag and is displayed by the voice tag editor. A storage mechanism is connected to the editor and is operable to update a lexicon with the displayed alphanumeric characters and the corresponding normalized text, thereby developing a desired voice tag “sounds like” pair.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an exemplary voice-tagging system;

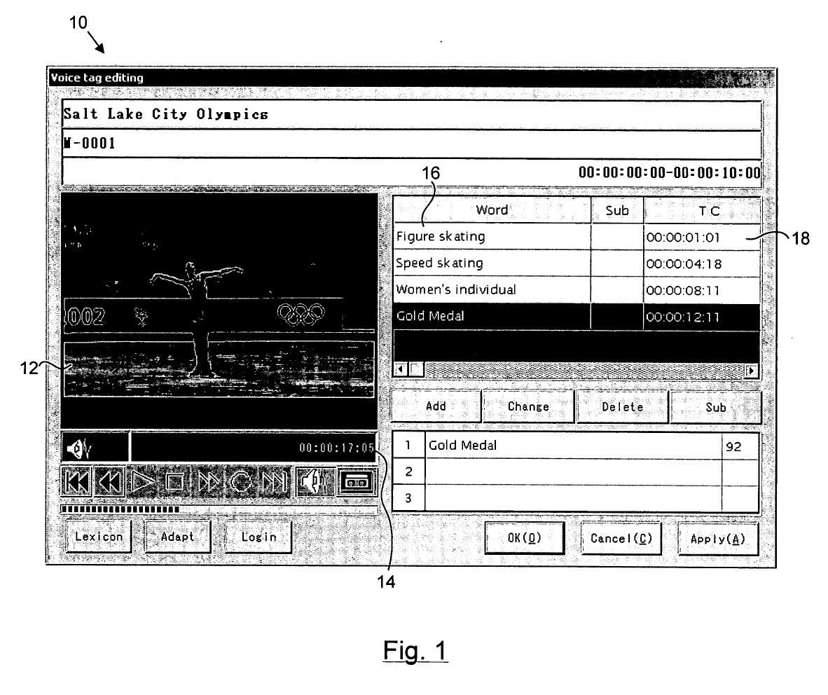

FIG. 2 is a functional block diagram of a voice-tagging lexicon system according to the present invention;

FIG. 3 is a functional block diagram of an exemplary text parsing and speech recognition system according to the present invention;

FIG. 4A is a user interface window for entering voice tags according to the present invention;

FIG. 4B is a user interface window for editing voice tag transcriptions according to the present invention;

FIG. 4C is a user interface window for testing voice tags according to the present invention; and

FIG. 5 is a flow diagram of a disambiguate function of a voice-tagging lexicon system according to the present invention.

### DETAILED DESCRIPTION OF THE PREFERRED EMBODIMENTS

The following description of the preferred embodiment(s) is merely exemplary in nature and is in no way intended to limit the invention, its application, or uses.

A voice-tag “sounds like” pair is a combination of two text strings, where the voice tag is the text that will be used to tag the multimedia data and the “sounds like” is the verbalization that the user is supposed to utter in order to insert the voice tag into the multimedia data. For example if the user wants to insert the voice tag “Address 1” when the phrase “101 Broadway St” is spoken, then the user creates a voice tag “sounds like” pair of “Address 1” and “101 Broadway St” in the voice-tagging lexicon.

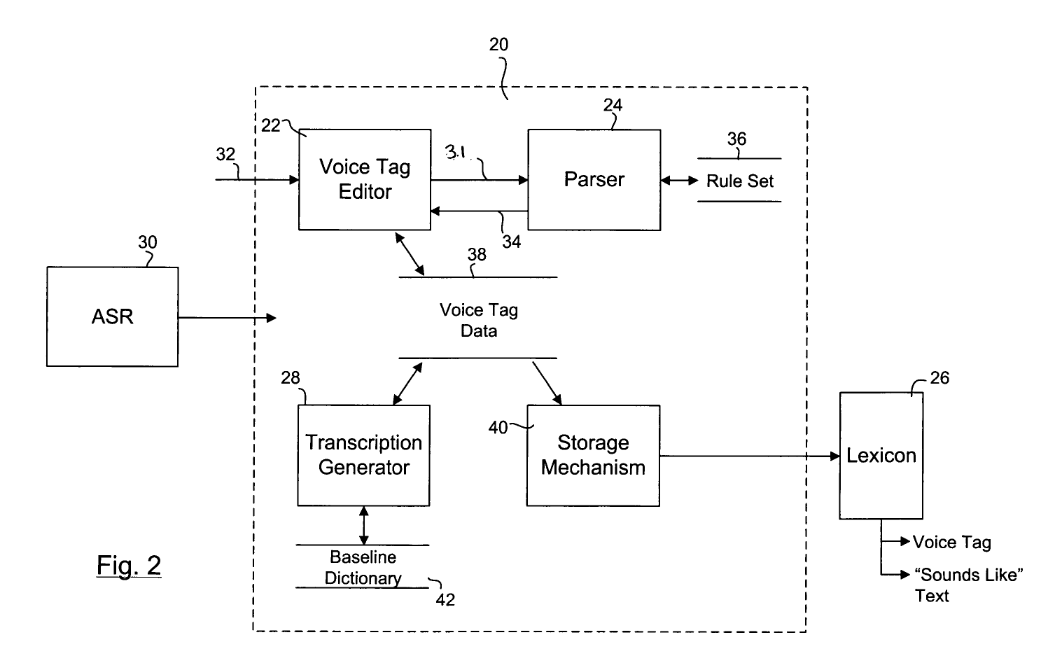

A voice-tagging system 20 for generating and/or modifying a voice-tagging lexicon is shown in FIG. 2. The system 20 includes a voice-tag editor 22, a text parser 24, a lexicon 26, a transcription generator 28, and an audio speech recognizer 30. A user enters alphanumeric input 32 that is indicative of a voice-tag at the voice-tag editor 22. The voice-tag editor 22 allows a user to view or edit voice-tags and associate with it “sound like” text which are stored in the lexicon 26. The lexicon 26 of the present invention is a voice-tagging speech lexicon that includes sets of voice-tag “sounds like” pairs.

The text parser 24 receives the alphanumeric “sounds like” input 31 from the voice-tag editor 22 and generates corresponding normalized text 34 according to a rule set 36. Normalization is the process of identifying alphanumeric input such as numbers, dates, acronyms, and abbreviations and transforming them into full text as is known in the art. The normalized text 34 serves as recognition text for the voice-tag and as user feedback for the voice tag editor 22. The voice-tag editor 22 is configured to display the voice-tag data 38 to the user. A storage mechanism 40 receives the voice-tag data 38 and updates the lexicon 26 with the voice-tag data 38. For example, a user may intend that “Address 1” is a voice-tag for “sounds-like” input of “101 Broadway St.” The parser generates transcriptions for the “sounds like” text. Subsequently, during the voice tagging process, if the user says “one oh one broadway street,” the voice-tag “Address 1” will be associated with the corresponding timestamp of the multimedia data.

The transcription generator 28 receives the voice-tag data 38. The transcription generator 28 may be configured in a variety of different ways. In one embodiment of the present invention, the transcription generator 28 accesses a baseline dictionary 42 or conventional letter-to-sound rules to produce a suggested phonetic transcription. An initial phonetic transcription of the alphanumeric input 34 may be derived through a lookup in the baseline dictionary 42. In the event that no pronunciation is found for the spelled word, conventional letter-to-sound rules may be used to generate an initial phonetic transcription.

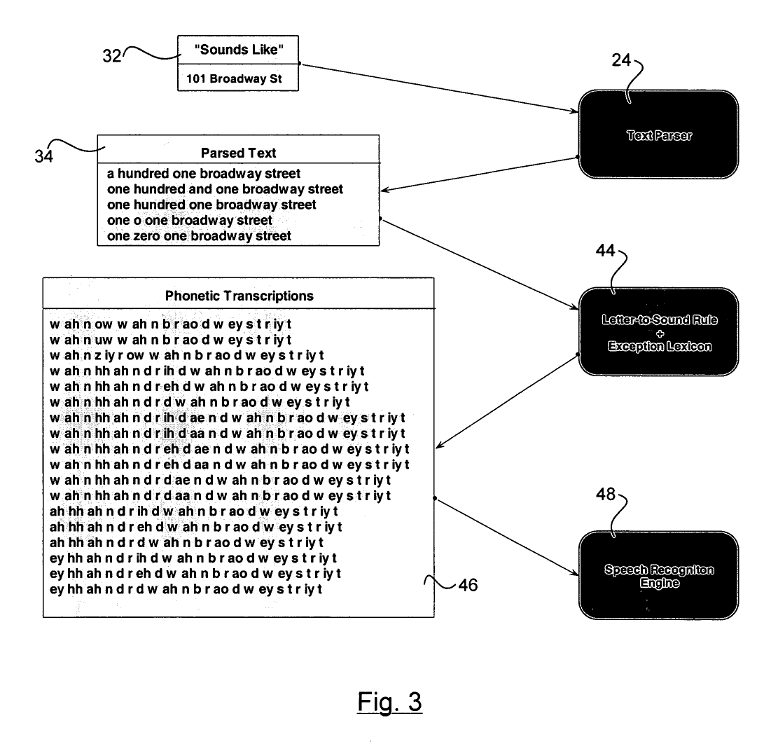

An exemplary voice-tag pair system is shown in FIG. 3. The “sounds like” input text 32 is received by the text parser 24. The text parser 24 generates parsed text 34 based on the “sounds like” input text 32. A letter-to-sound rule set 44 is used to determine phonetic transcriptions 46 of the parsed text 34. The letter-to-sound rule set 44 may operate in conjunction with an exception lexicon as is known in the art. The phonetic transcriptions 46 are used by a speech recognition engine 48 to match speech input with a corresponding voice-tag.

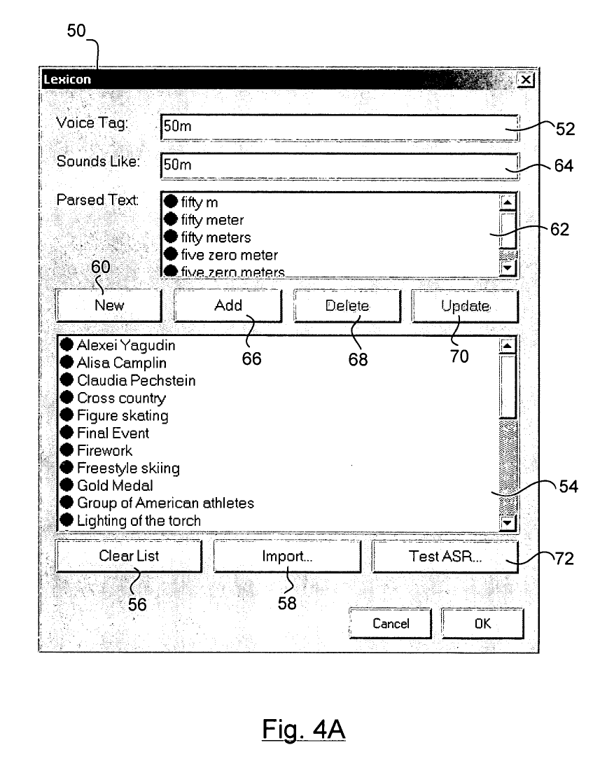

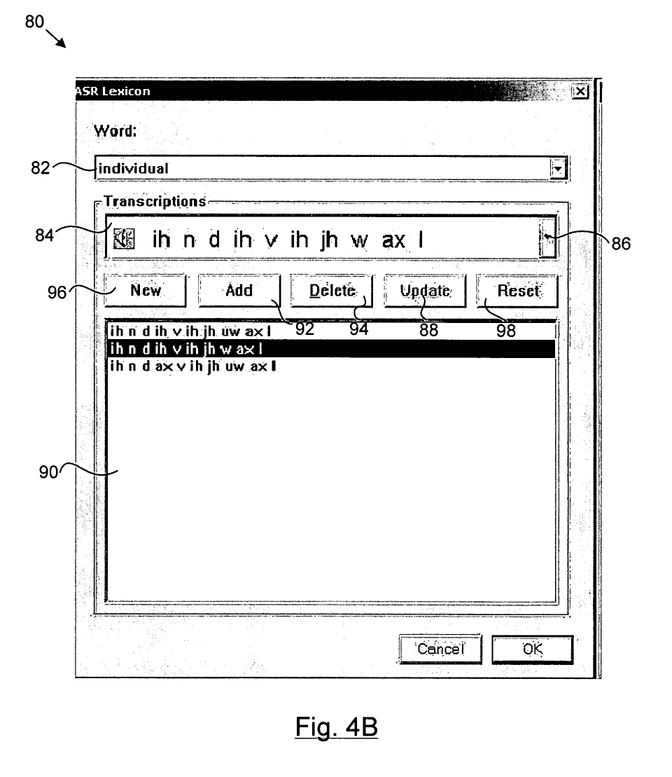

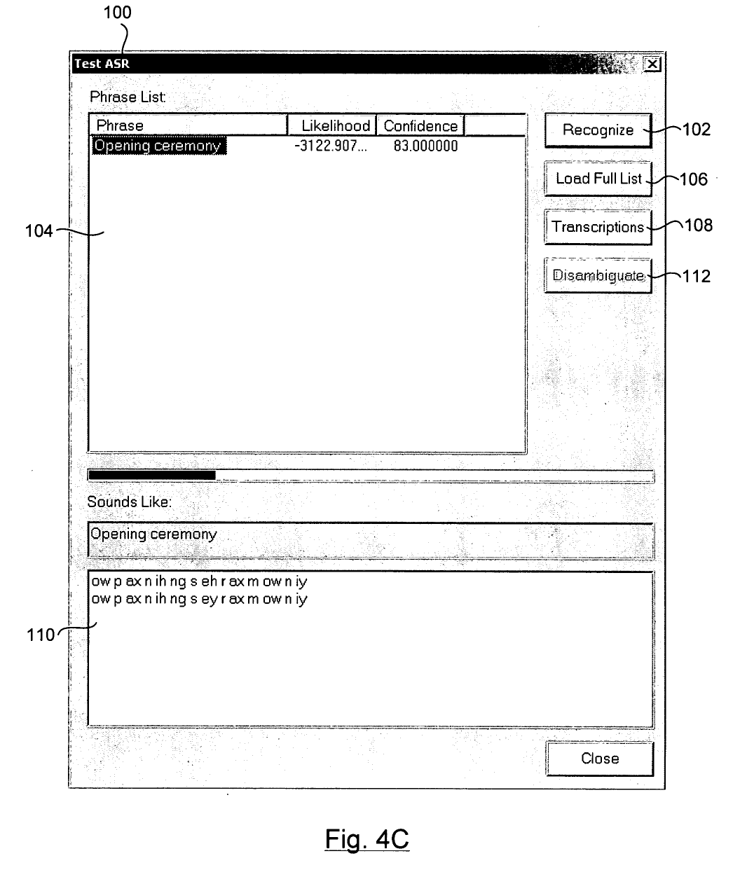

An exemplary voice-tag editor allowing the user to input and/or modify voice-tags is shown in FIGS. 4A, 4B, and 4C. Referring to FIG. 4A, the user enters the alphanumeric input in a lexicon window 50 at a voice-tag field 52. For example, the user enters the alphanumeric input via a keyboard. Alternatively, the use may enter the alphanumeric input using other suitable means, such as voice input. Alternatively, the user may select an existing voice-tag from a voice-tag lexicon window 54. All of the voice-tags in the currently-selected lexicon are displayed in the voice-tag lexicon window 54. The user may clear the currently-selected lexicon by selecting the clear list button 56. Alternatively, the user may import new voice-tag lexicon by selecting the import button 58. The user may select a “new” button 60 to clear all fields and begin anew.

As the user enters the alphanumeric input in the voice-tag field 52, the parser operates automatically on the alphanumeric input and returns normalized text in a parsed text field 62. A “sounds-like” field 64 is initially automatically filled in with text identical to the alphanumeric input entered in the voice-tag field 52. The user may view the normalized text to determine if the parser correctly parsed the alphanumeric input and select a desired entry from the parsed text field 62. In other words, the user may wish that the voice tag “50 m” be associated with the spoken input “fifty meters.” Therefore, the user selects “fifty meters” from the parsed text field 62. The “sounds-like” field 64 is subsequently filled in with the selected entry. If the normalized text in the parsed text field 62 is not correct, the user may modify the “sounds-like” field 64. The parser operates automatically on the modified “sounds-like” field 64 to generate revised normalized text in the parsed text field 62. Additionally, the voice-tag editor may notify the user that the alphanumeric input is not able to be parsed. For example, if the alphanumeric input includes a symbol that cannot be parsed, the voice-tag editor may prompt the user to replace the symbol or the entire alphanumeric input.

The user may add the voice-tag in the voice tag field 52 to the lexicon by selecting the add button 66. The voice-tag will be stored as a voice-tag recognition pair with the text in the “sounds-like” field 62. A transcription generator generates a phonetic transcription of the “sounds-like” field 62. Henceforth, the phonetic transcription will be paired with the corresponding voice-tag. Adding the voice-tag to the lexicon will cause the voice-tag to be displayed in the voice-tag lexicon window 54. The user can delete voice-tags from the lexicon by selecting a voice-tag from the voice-tag lexicon window 54 and selecting a delete button 68. The user can update a selected voice-tag by selecting the update button 70. The user can test the audio speech recognition associated with a voice-tag by selecting a test ASR button 72. The update and test ASR functions of the voice-tag editor are explained in more detail in FIGS. 4B and 4C, respectively.

Referring now to FIG. 4B, the user may edit a selected voice-tag in a transcription editor window 80 by selecting the update button 70 of FIG. 4A. The selected voice-tag appears in a word field 82. An n-best list of possible transcriptions of the selected voice-tag appears in a transcription field 84. In one embodiment, a phoneticizer generates the transcriptions based on the “sounds like” field 64 of FIG. 4A. The phoneticizer generates the n-best list of suggested phonetic transcriptions using a set of decision trees. Each transcription in the suggested list has a numeric value by which it can be compared with other transcriptions in the suggested list. Typically, these numeric scores are the byproduct of the transcription generation mechanism. For example, when the decision-tree based phoneticizer is used, each phonetic transcription has associated therewith a confidence level score. This confidence level score represents the cumulative score of the individual probabilities associated with each phoneme. Leaf nodes of each decision tree in the phoneticizer are populated with phonemes and their associated probabilities. These probabilities are numerically represented and can be used to generate a confidence level score. Although these confidence level scores are generally not displayed to the user, they are used to order the displayed list of n-best suggested transcriptions as provided by the phoneticizer. A more detailed description of a suitable phoneticizer and transcription generator can be found in U.S. Pat. No. 6,016,471 entitled “METHOD AND APPARATUS USING DECISION TREE TO GENERATE AND SCORE MULTIPLE PRONUNCIATIONS FOR A SPELLED WORD,” which is hereby incorporated by reference.

The user may select the correct transcription from the n-best list by selecting a drop-down arrow 86. The user may edit the existing transcription that appears in the transcription field 84 if none of the transcriptions in the n-best list are correct. The user may select an update button 88 to update a transcription list 90. The user can add a selected transcription to the transcription list 90 by selecting an add button 92. The user can delete a transcription from the transcription list 90 by selecting a delete button 94. The user may select a “new” button 96 to clear all fields and begin anew.

The transcriptions in the transcription list 90 represent possible pronunciations of the selected voice-tag. For example, as shown in FIG. 4B, the word “individual” may have more than one possible pronunciation. Therefore, the user can ensure that any spoken version of a word is recognized as the desired voice-tag to compensate for different accents, dialects, and mispronunciations. The user may add the transcription in the transcription field 84 to the transcription list 90 as a possible pronunciation of the selected voice-tag in the word field 82 by selecting the add button 92. If the user selects a transcription from the transcription list 90, the transcription appears in the transcription field 84. The user may then edit or update the selected transcription by selecting the update button 88. The user may select a reset button 98 to revert all of the transcriptions in the transcription list 90 to a state prior to any modifications.

Referring back to FIG. 4A, the user may test a voice-tag with an audio speech recognizer (ASR) by selecting the test ASR button 72. Selecting the test ASR button 72 brings up a test ASR window 100 as shown in FIG. 4C. The user selects a recognize button 102 to initiate an ASR test. The user speaks a voice-tag into an audio input mechanism after selecting the recognize button 102. The ASR generates one or more suggested voice-tags in a phrase list 104 in response to the spoken voice-tag. The phrase list 104 is an n-best list, including likelihood and confidence measures, based on the spoken voice-tag. Alternatively, the user may select a load full list button 106 to display the entire lexicon in the phrase list 104. The user may select a particular voice-tag from the phrase list 104 and test the ASR as described above. After the ASR performs the recognition test, an n-best list replaces the entire lexicon in the phrase list 104. The user may select a transcriptions button 108 to display the phonetic transcriptions for a selected voice-tag in a transcriptions list window 110. The phonetic transcriptions are used by the ASR to match the word spoken during the recognition test with the correct voice-tag. These phonetic transcriptions represent the phrases that will be used by the recognizer during voice-tagging operations.

The user may reduce potential recognition confusion by selecting a disambiguate button 112. For example, selecting the disambiguate button 112 initiates a procedure to minimize recognition confusion by detecting if two or more words are confusingly similar. The user may then have the option of selecting a different phrase to use for a particular voice-tag to avoid confusion. Alternatively, the user interface may employ other methods to optimize speech ergonomics. “Speech ergonomics” refers to addressing potential problems in the voice-tag lexicon to avoid problems in the voice-tagging process. Such problems are further described below.

One known problem in speech recognition is confusable speech entries. In the context of voice-tagging, confusable speech entries are phrases in the lexicon that are very close in pronunciation. In one scenario, one or more isolated words such as “car” and “card” may have confusingly similar pronunciations. Similarly, certain combinations of words may have confusingly similar pronunciations. Another problem of speech recognition is unbalanced phrase lengths. Unbalanced phrase lengths can occur when there are some phrases in the lexicon that are very short and some phrases that are very long. The length of a particular phrase is not determined by the length of the alphanumeric input or “sounds like” field. Instead, the length is indicative of the phonetic transcription associated therewith. Still another problem of speech recognition is hard-to-pronounce phrases. Such phrases require increased attention and effort to verbalize.

In order to compensate for confusingly similar entries, the present invention may incorporate technology to measure the similarity of two or more transcriptions. For example, a measure distance may be generated that indicates the similarity of two or more transcriptions. A measure distance of zero indicates that two confusingly similar entries are identical. In other words, measure distance increases as similarity decreases. The measure distance may be calculated using a variety of suitable methods. Source code for an exemplary measure distance method is provided at Appendix A. One method measures the number of edits that would be necessary to make a first transcription identical to a second transcription. “Edits” refers to insert, delete, and replace operations. Each particular edit may have a corresponding penalty. Penalties for all edits may be stored in a penalty matrix. Another method to generate the measure distance is to build actual speech recognition grammar for each entry to determine a difference between Hidden Markov Models (HMM) that correspond to each entry. For example, the difference between the HMMs may be determined using an entropy measure.

With respect to unbalanced phrase lengths, the speech recognition technology of the present invention operates on the “sounds like” field. In other words, the lengths of the transcriptions associated with the “sounds like” field are compared. One method to address the problem of unbalanced phrase lengths is to build a length histogram that represents the distribution of phrases with a particular length. The present invention may incorporate statistical analysis methods to identify phrases that diverge too much from a center of the histogram and mark such phrases as too short or too long.

With respect to hard-to-pronounce phrases, such phrases can be identified by observing the syllabic structure of the phrases. Each phrase is syllabified so the individual syllables may be noted. The syllables may then be identified as unusual or atypical. The method for identifying the syllables can be a rule-or-knowledge based system, a statistical learning system, or a combination thereof. The unusual syllables may be caused by a word with an unusual pronunciation, a word having a problem with the letter-to-sound rules, or a combination thereof. Additionally, a transcription that is incorrectly entered by the user may be problematic. A problematic transcription may be marked for future resolution. Subsequently, inter-word and/or inter-phrase problems are analyzed.

Therefore, the above problems may be addressed by the voice-tag editor of the present invention. For instance, referring back to FIG. 4C, the test ASR window 100 may include additional buttons for correcting one or more of the above problems. After the recognition takes place, the user may be notified of a potential problem. The user may then select the corresponding button to attempt to correct the problem. Additionally, the voice-tag editor may incorporate a confusability window that generates a two-dimensional map of confusable entries. The two-dimensional map may be generated using multi-dimensional scaling techniques that render points in space based only on distances between the entries. In this manner, the user is able to observe a visual representation of confusingly similar entries.

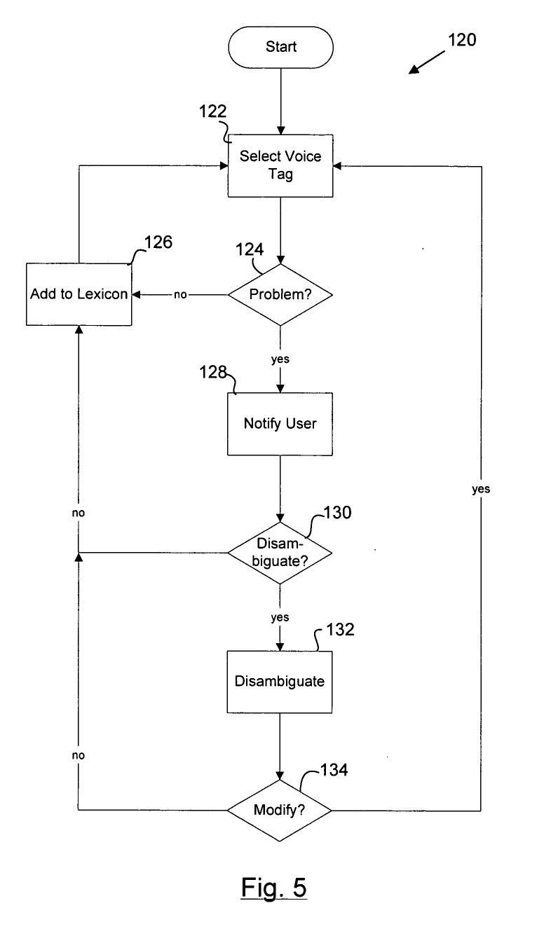

An exemplary disambiguating process 120 for a voice-tag editor is shown in FIG. 5. The user selects a voice-tag at step 122. The voice-tag editor determines whether the selected voice-tag is problematic at step 124. For example, the voice-tag editor may determine if the selected voice-tag is confusingly similar with another voice-tag, has an unbalanced phrase length, or is hard-to-pronounce as described above. If the selected voice-tag is not problematic, the user may proceed to add the selected voice-tag to the lexicon at step 126. If the selected voice-tag is problematic, the voice-tag editor proceeds to step 128. At step 128, the voice-tag editor notifies the user of the problem with the selected voice-tag. For example, the disambiguate button 112 of FIG. 4C may be initially unavailable to the user.

Upon detection of a problem with the selected voice-tag, the disambiguate button 112 becomes available for selection. At step 130, the user may continue to add the selected voice-tag to the lexicon or disambiguate the selected voice-tag at step 132. For example, the user may select the disambiguate button 112. The voice-tag editor may provide various solutions for the problem. For example, the voice-tag editor may incorporate a thesaurus. If the desired voice-tag entered by the user is determined to have one or more of the above-mentioned problems, the voice-tag editor may provide synonyms to the spoken phrase for the voice-tag that would avoid the problem. In other words, if the spoken phrase “fifty meters” sounds confusingly similar to “fifteen meters,” the voice-tag editor may suggest that the spoken phrase “five zero meters” be used. Additionally, the voice-tag editor may give the user the option of editing one or more of the transcriptions associated with the selected voice-tag. The user may ignore the suggestions of the voice-tag editor and continue to add the selected voice-tag to the lexicon, or modify the voice-tag, at step 134.

The description of the invention is merely exemplary in nature and, thus, variations that do not depart from the gist of the invention are intended to be within the scope of the invention. Such variations are not to be regarded as a departure from the spirit and scope of the invention.

APPENDIX A

```
#ifdef _MSC_VER
#pragma once
#pragma warning (disable : 4786)
#pragma warning (disable : 4503)
#endif
#include <assert.h>
#include <vector>
#include <string>
#include <algorithm>
#include <functional>
#include <stddef.h>
#include <stdlib.h>
#include <ctype.h>
#include <stdio.h>
#include <string.h>
#include <locale.h>
#include “EditDist.h”
#ifndef max
#define max(a,b)  (((a) > (b)) ? (a) : (b))
#endif
#ifndef min
#define min(a,b)  (((a) < (b)) ? (a) : (b))
#endif
struct DynProgMatrixElem
{
    enum {dptIdt, dptSub, dptIns, dptDel};
    DynProgMatrixElem( )
        : m_dblCost(0.0), m_nPrev_i(−1), m_nPrev_j(−1), m_nType(dptIdt)
{ }
    DynProgMatrixElem(double dblCost, int nPrev_i, int nPrev_j, int nType)
        : m_dblCost(dblCost), m_nPrev_i(nPrev_i), m_nPrev_j(nPrev_j),
m_nType(nType) { }
    double m_dblCost;
    int m_nPrev_i;
    int m_nPrev_j;
    int m_nType;
};
typedef std::vector<std::vector<DynProgMatrixElem> > DynProgMatrix;
void GetAligned(
    const DynProgMatrix& m,
    const std::vector<std::string>& s1,
    const std::vector<std::string>& s2,
    std::vector<std::vector <AlignType> >& vectSubst
)
{
    std::vector <AlignType> curGroup;
    int i = s1.size( );
    int j = s2.size( );
    while (i > 0 ∥ j > 0) {
        if (i > 0 && j > 0) {
            if (m[i][j].m_nType == DynProgMatrixElem::dptIdt) {
                i−−; j−−;
                assert (s1[i] == s2[j]);
                if (!curGroup.empty( )) {
                    std::reverse(curGroup.begin( ),
curGroup.end( ));
                    vectSubst.push_back(curGroup);
                    curGroup.resize(0);
                }
            } else if (m[i][j].m_nType == DynProgMatrixElem::dptSub) {
                i−−; j−−;
                assert (s1[i] != s2[j]);
                curGroup.push_back(AlignType(s1[i], s2[j]));
            } else if (m[i][j].m_nType == DynProgMatrixElem::dptIns) {
                i−−;
                curGroup.push_back(AlignType(s1[i], “−”));
            } else if (m[i][j].m_nType == DynProgMatrixElem::dptDel){
                j−−;
                curGroup.push_back(AlignType(“−”, s2[j]));
            } else {
                assert(false);
            }
        } else if(i > 0) {
            i−−;
            curGroup.push_back(AlignType(s1[i], “−”));
        } else if(j > 0) {
            j−−;
            curGroup.push_back(AlignType(“−”, s2[j]));
        }
    }
    if (!curGroup.empty( )) {
        std::reverse(curGroup.begin( ), curGroup.end( ));
        vectSubst.push_back(curGroup);
    }
    std::reverse(vectSubst.begin( ), vectSubst.end( ));
}
void FindEditDist(
    const std::vector<std::string>& outPhoneString,
    const std::vector<std::string>& refPhoneString,
    const PenaltyMap& mapPenalty,
    std::vector<std::vector <AlignType> >& vectSubst,
    double& dblCost)
{
    DynProgMatrix C;  /* the cost matrix for dynamic programming
*/
    int i,j;  /* control vars */
    static std::string sil(“−”);
    /* First, initialize all matrices */
    C.resize(outPhoneString.size( ) + 1,
std::vector<DynProgMatrixElem>(refPhoneString.size( ) + 1));
    /* Initialize 0 row & 0 column */
    for (i = 1; i <= outPhoneString.size( ); i++) {
        const double dblPenalty = mapPenalty.find(std::make_pair(sil,
outPhoneString[i−1]))->second;
        C[i][0].m_dblCost = C[i−1][0].m_dblCost + dblPenalty;
        C[i][0].m_nType  = DynProgMatrixElem::dptIns;
    }
    for (j = 1; j <= refPhoneString.size( ); j++) {
        const double dblPenalty =
mapPenalty.find(std::make_pair(refPhoneString[j−1], sil))->second;
        C[0][j].m_dblCost = C[0][j−1].m_dblCost + dblPenalty;
        C[0][j].m_nType  = DynProgMatrixElem::dptDel;
    }
    /* Here comes main loop */
    for (i=1; i <= outPhoneString.size( ); i++) {
        for (j=1; j <= refPhoneString.size( ); j++) { /* dynamic programming
loop */
            if (outPhoneString[i−1] == refPhoneString[j−1]) {
                C[i][j] = DynProgMatrixElem(C[i−1][j−1].m_dblCost, i−1,
j−1, DynProgMatrixElem::dptIdt);
            } else { /* “else” for substitution, insertion, & deletion */
                const double dblSubPenalty =
mapPenalty.find(std::make_pair(outPhoneString[i−1], refPhoneString[j−1]))-
>second;
                const  double  dblInsPenalty  =
mapPenalty.find(std::make_pair(sil, outPhoneString[i−1]))->second;
                const double dblDelPenalty =
mapPenalty.find(std::make_pair(refPhoneString[j−1], sil))->second;
                const double subDist = C[i−1][j−1].m_dblCost +
dblSubPenalty;
                const double insDist = C[i−1][j].m_dblCost +
dblInsPenalty;
                const double delDist = C[i][j−1].m_dblCost +
dblDelPenalty;
                if ((subDist <= insDist) && (subDist <= delDist)) {
                    C[i][j] = DynProgMatrixElem(subDist, i−1, j−1,
DynProgMatrixElem::dptSub);
                } else if ((insDist <= subDist) && (insDist <= delDist)) {
                    C[i][j] = DynProgMatrixElem(insDist, i−1, j,
DynProgMatrixElem::dptIns);
                } else if ((delDist <= subDist) && (delDist <= insDist)) {
                    C[i][j] = DynProgMatrixElem(delDist, i, j−1,
DynProgMatrixElem::dptDel);
                } else {
                    assert(false);
                }
            }
        } /* end of dynamic programming loop */
    }
    GetAligned(C, outPhoneString, refPhoneString, vectSubst);
    dblCost = C[outPhoneString.size( )][refPhoneString.size( )].m_dblCost;
}
void ConvertStringToArray(const std::string& strPho, std::vector<std::string>&
vectPho)
{
    int i;
    bool blsPrevSpace = true;
    int iCur = −1;
    for (i = 0; i < strPho.size( ); i++) {
        bool blsSpace = (strPho[i] == ‘ ’);
        if (!blsSpace) {
            if (blsPrevSpace) {
                vectPho.push_back(“”);
                iCur++;
            }
            vectPho[iCur] += strPho[i];
        }
        blsPrevSpace = blsSpace;
    }
}
std::string ConcatenateStringVector(const std::vector<std::string>& vectStrings)
{
    std::string strReturn;
    for (int i = 0; i < vectStrings.size( ); i++) {
        strReturn += vectStrings[i] + “ ”;
    }
    return strReturn;
}
```

1. A system for developing voice tag “sounds like” pairs for a voice tagging lexicon, comprising:
a voice tag editor receptive of alphanumeric characters indicative of a voice tag, the voice tag editor configured to display and edit the alphanumeric characters;
a text parser connected to the editor and operable to generate normalized text corresponding to the alphanumeric characters, such that the normalized text serves as recognition text for the voice tag and is displayed by the voice tag editor; and
a storage mechanism connected to the editor and operable to update a lexicon with the displayed alphanumeric characters and the corresponding normalized text, thereby developing a desired voice tag “sounds like” pair.

2. The system of claim 1 wherein the alphanumeric characters indicative of a voice tag are typed in via a keyboard connected to the voice tag editor.

3. The system of claim 1 wherein the voice tag editor is connected to the lexicon and further configured to display a list of voice tags residing in the lexicon.

4. The system of claim 1 wherein the normalized text residing in the lexicon is used by a speech recognizer in a voice tagging system.

5. The system of claim 1 wherein the voice tag editor is further configured to display a description associated with the lexicon, wherein the description is a summary of contents of the lexicon.

6. The system of claim 1 wherein the voice tag editor is configured to import the lexicon from an external data source.

7. The system of claim 6 wherein the external data source receives a request from the voice tag editor.

8. The system of claim 7 wherein the external data source is configured to provide a list of available lexicons to the voice tag editor according to the request.

9. The system of claim 7 wherein the request includes content requirements for a lexicon.

10. The system of claim 1 wherein the voice tag editor is configured to modify existing voice tag “sounds like” pairs stored on the lexicon.

11. The system of claim 4 wherein the voice tag editor is configured to modify a phonetic transcription used by the speech recognizer.

12. The system of claim 1 wherein the text parser prompts a user of the voice tagging system if the text parser is not able to generate the normalized text.

13. The system of claim 1 wherein the voice tag editor is configured to perform a speech recognition test of the desired voice tag “sounds like” pair.

14. The system of claim 13 wherein the voice tag editor is configured to modify the desired voice-tag “sounds like” pair if the speech recognition test is not successful.

15. The system of claim 13 wherein the voice tag editor generates a list of n-best recognition results in response to the speech recognition test.

16. The system of claim 15 wherein the list includes at least one of a confidence measure and a likelihood measure for the recognition results.

17. The system of claim 1 wherein the voice tag editor is configured to upload the lexicon to a remote location.

18. The system of claim 17 wherein the uploaded lexicon includes a description of content of the uploaded lexicon.

19. The system of claim 1 wherein the voice tag editor is operable to identify at least one other voice tag “sounds like” pair having recognition text that is confusingly similar to the recognition text of the desired voice tag “sounds like” pair.

20. The system of claim 19 wherein identifying the at least one other voice tag “sounds like” pair includes calculating a measure distance between phonetic transcriptions associated with each recognition text, where the measure distance is indicative of similarity between the phonetic transcriptions.

21. The system of claim 20 wherein the measure distance is based on a number of edit operations needed to make the phonetic transcriptions identical.

22. The system of claim 19 wherein the voice tag editor is further operable to provide alternative recognition text of the desired voice tag “sounds like” pair.

23. The system of claim 1 wherein the voice tag editor is operable to detect an unbalanced phrase length of the desired voice tag “sounds like” pair.

24. The system of claim 23 wherein the voice tag editor is further operable to provide alternative recognition text of the desired voice tag “sounds like” pair.

25. The system of claim 1 wherein the voice tag editor is operable to detect a hard-to-pronounce desired voice tag “sounds like” pair.

26. The system of claim 25 wherein the voice tag editor is further operable to provide alternative recognition text of the desired voice tag “sounds like” pair.

27. A method for modifying a voice-tagging lexicon comprising:
receiving alphanumeric characters indicative of a voice tag;
generating normalized text corresponding to the alphanumeric characters and displaying the normalized text, such that the normalized text serves as recognition text for the voice tag; and
updating the voice-tagging lexicon with the alphanumeric characters and the corresponding normalized text, thereby developing a desired voice tag “sounds like” pair.

28. The method of claim 27 wherein the step of receiving comprises displaying a list of voice tags residing in the lexicon and selecting a voice tag from the list.

29. The method of claim 27 further comprising disambiguating the recognition text.

30. The method of claim 27 further comprising receiving speech input and matching the speech input to the voice tag “sounds like” pair according to the normalized text.

31. The method of claim 27 further comprising displaying a description associated with the lexicon, wherein the description is a summary of contents of the lexicon.

32. The method of claim 27 further comprising importing the lexicon from an external data source.

33. The method of claim 32 further comprising providing a list of available lexicons according to a request.

34. The method of claim 27 further comprising modifying existing voice tag “sounds like” pairs that are stored on the lexicon.

35. The method of claim 30 further comprising modifying a phonetic transcription set associated with the speech input.

36. The method of claim 27 further comprising prompting a user of the voice tagging system if the text parser is not able to generate the normalized text.

37. The method of claim 27 further comprising performing a speech recognition test of the desired voice tag “sounds like” pair.

38. The method of claim 37 further comprising modifying the desired voice-tag “sounds like” pair if the speech recognition test is not successful.

39. The method of claim 37 further comprising modifying a phonetic transcription set used by the speech recognition test it the speech recognition test is not successful.

40. The method of claim 37 further comprising generating a list of n-best recognition results in response to the speech recognition test.

41. The method of claim 27 further comprising uploading the lexicon to a remote location.

42. The method of claim 29 wherein disambiguating includes identifying at least one other voice tag “sounds like” pair having recognition text that is confusingly similar to the recognition text of the desired voice tag “sounds like” pair.

43. The system of claim 42 wherein identifying the at least one other voice tag “sounds like” pair includes calculating a measure distance between phonetic transcriptions associated with each recognition text, where the measure distance is indicative of similarity between the phonetic transcriptions.

44. The method of claim 29 wherein disambiguating includes determining if a phonetic transcription associated with the recognition text has an unbalanced phrase length.

45. The method of claim 29 wherein disambiguating includes determining if a phonetic transcription associated with the recognition text is a hard-to-pronounce phrase.

46. The method of claim 29 further comprising providing alternative recognition text of the desired voice tag “sounds like” pair.
